(19) United States
(12) Patent Application Publication
(10) Pub. No.: US 2014/0351604 A1
(43) Pub. Date: Nov. 27, 2014

(54) ELECTRONIC DEVICE AND ENCRYPTION CONTROL METHOD

(71) Applicant: KABUSHIKI KAISHA TOSHIBA, Tokyo (JP)

(72) Inventors: Akemi Kayama, Tachikawa-shi (JP); Jun Takeda, Hamura-shi (JP)

(73) Assignee: KABUSHIKI KAISHA TOSHIBA, Tokyo (JP)

(21) Appl. No.: 14/166,631

(22) Filed: Jan. 28, 2014

(30) Foreign Application Priority Data
May 21, 2013 (JP) 2013-107261

(51) Int. Cl. G06F 21/60

(52) U.S. Cl. CPC G06F 21/60
USPC 713/193

(57) ABSTRACT

According to at least one embodiment, an electronic device includes a storage comprising a plurality of sectors and a processor configured to encrypt data in the plurality of sectors of the storage. The processor is configured to cause to be stored in a storage area address information indicating a defective sector from which data cannot be read, when the defective sector is detected during encryption.

### CROSS-REFERENCE TO RELATED APPLICATIONS

This application is based upon and claims the benefit of priority from Japanese Patent Application No. 2013-107261, filed May 21, 2013, the entire contents of which are incorporated herein by reference.

### FIELD

Embodiments described herein relate generally to an electronic device and an encryption control method to be applied to the electronic device.

### BACKGROUND

In recent years, various electronic devices such as tablet computers and notebook personal computers (PC) have been developed. Such types of electronic devices mostly have auxiliary storages such as hard disk drives (HDD).

Also, in recent years, encryption techniques have been developed each of which encrypts data to be stored in a storage medium, e.g., a hard disk, in an auxiliary storage. This encryption of data can prevent, e.g., leakage of information.

However, in such a technique, there is a case where a sector whose data cannot be read during encryption of data in a hard disk is detected. In this case, the data in the sector cannot be encrypted. However, there is also a case where the data of the sector becomes readable later on. Therefore, if a sector whose data cannot be encrypted is present, it increases the possibility of information being leaked.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an appearance of an electronic device according to an embodiment.

FIG. 2 is a view for showing an example of a system configuration of the electronic device according to the embodiment.

FIG. 3 is a view for use in explaining an outline of encryption control processing to be executed by the electronic device according to the embodiment.

FIG. 4 is a block diagram for showing a configuration of an encryption control program to be executed by the electronic device according to the embodiment.

FIG. 5 is a flowchart of a procedure of the encryption control processing to be executed by the electronic device according to the embodiment.

FIG. 6 is a flowchart of a procedure of a defective-sector recovery processing in the encryption control processing to be executed by the electronic device according to the embodiment.

FIG. 7 is a flowchart of a procedure of processing to be executed in response to a write request, in the encryption control processing to be executed by the electronic device according to the embodiment.

FIG. 8 is a flowchart of a processing to be executed in response to a read request, in the encryption control processing to be executed by the electronic device according to the embodiment.

FIG. 9 is a view for use in explaining an example of a list of defective sectors, which is stored by the encryption control processing to be executed by the electronic device according to the embodiment.

### DETAILED DESCRIPTION

Various embodiments will be described hereinafter with reference to the accompanying drawings.

In general, according to one embodiment, an electronic device includes a storage comprising a plurality of sectors and a processor configured to encrypt data in the plurality of sectors of the storage. The processor is configured to cause to be stored in a storage area address information indicating a defective sector from which data cannot be read, when the defective sector is detected during encryption.

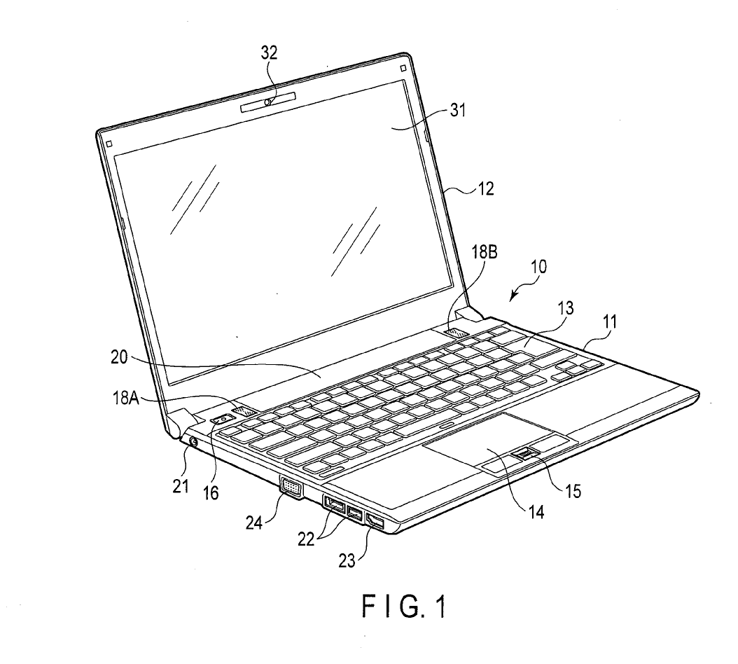

First of all, a structure of the electronic device according to an embodiment will be explained with reference to FIG. 1. As the electronic device, various electronic devices such as a notebook personal computer and a tablet terminal can be provided. The following explanation is given with respect to the case where the electronic device is provided as a notebook personal computer 10.

FIG. 1 is a perspective view of a front side of the computer 10, which is located, with a display unit opened. The computer 10 includes a computer main body 11 and the display unit 12. The display unit 12 incorporates a display device such as a liquid crystal display device (LCD) 31. Also, at an upper end portion of the display unit 12, a camera (Web camera) 32 is provided. Furthermore, the computer 10 is configured to receive power from a battery 20.

The display unit 12 is attached to the computer main body 11 in such a way as to be rotatable between an open position in which an upper surface of the computer main body 11 is exposed and a closed position in which the upper surface of the computer main body 11 is covered by the display unit 12. The computer main body 11 has a thin box-shaped housing, and at an upper surface of the computer main body 11, a keyboard 13, a touch pad 14, a fingerprint sensor 15, a power switch 16 for turning on/off the computer 10 and speakers 18A and 18B are arranged. Also, at a left side surface of the computer main body 11, USB ports 22 are provided to enable USB devices to be connected to the computer main body 11.

Furthermore, at the computer main body 11, a power connector 21 is provided. To be more specific, the power connector 21 is provided at, e.g., a left side surface of the computer main body 11. To the power connector 21, an external power device is removably connected. As the external power device, an AC adapter can be applied. The AC adapter is a power device for converting utility power (AC power) into DC power.

The battery 20 is removably set in, e.g., a rear end portion of the computer main body 11. The battery 20 may be provided as a battery incorporated in the computer 10.

The computer 10 is driven by power supplied from the external power device or the battery 20. If the external power device is connected to the power connector 21 of the computer 10, the computer 10 is driven by power supplied from the external power device. The power from the external power device is also used to charge the battery 20. On the other hand, if the external power device is not connected to the power connector 21 of the computer 10, the computer 10 is driven by power supplied from the battery 20.

Furthermore, the computer main body 11 includes the USB ports 22, a high-definition multimedia interface (HDMI, registered trademark) output terminal 23 and an RGB port 24.

In the computer main body 11, a mass storage device such as a hard disk drive or a solid-state drive is provided. This storage device functions as a nonvolatile storage which can store various data including system data and user data. The computer 10 has an encryption function of encrypting data in an entire storage area of the storage device. In the case where the data in the entire storage area of the storage device is encrypted, even if taking out the storage device from the computer 10, a third person can be prevented from accessing the data in the storage device.

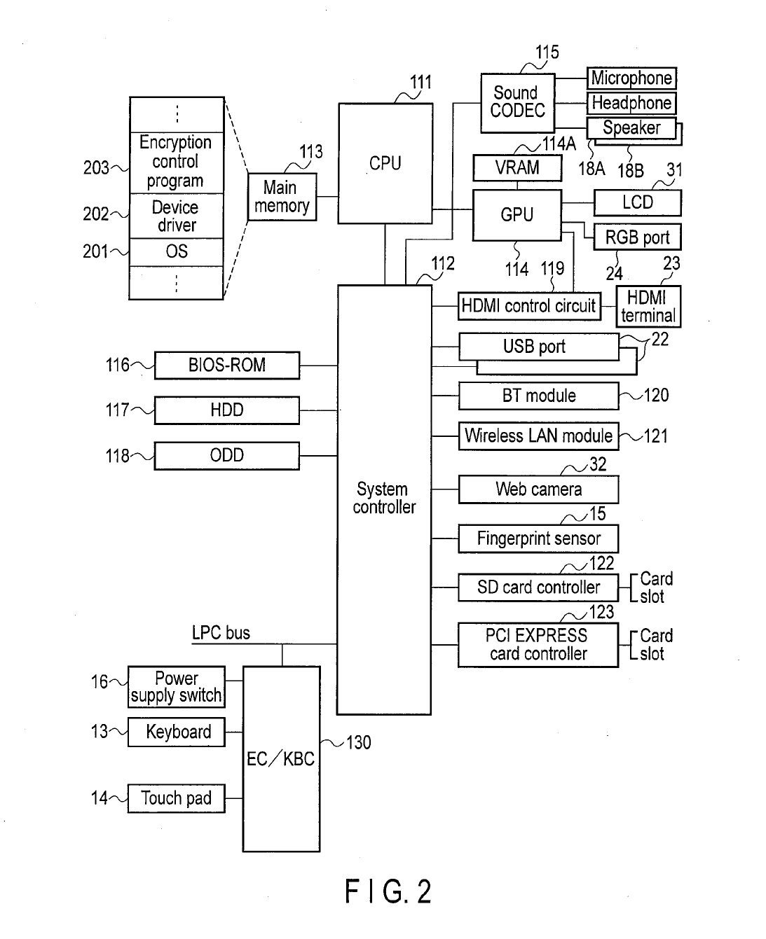

FIG. 2 shows a system configuration of the computer 10.

The computer 10 includes a CPU 111, a system controller 112, a main memory 113, a graphics processing unit (GPU) 114, a sound codec 115, a BIOS-ROM 116, a hard disk drive (HDD) 117, an optical disk drive (ODD) 118, a Bluetooth (BT, registered trademark) module 120, a wireless LAN module 121, the wireless LAN module 121, an SD card controller 122, a PCI EXPRESS card controller 123, an embedded controller/keyboard controller IC(EC/KBC) 130, etc.

The CPU 111 is a processor configured to control operations of components of the computer 10. The CPU 111 executes various software loaded from the HDD 117 into the main memory 113. The software includes an operating system (OS) 201, a device driver 202 and various application programs. The application programs include an encryption control program 203. The encryption control program 203 is a program which encrypts data in the entire area of the HDD 117 in units of one sector. It should be noted that the encryption control program 203 may run in the background when the OS 201 is driven, or may be executed in response to an instruction given from the OS 201. Also, the encryption control program 203 can start encryption in accordance with, e.g., an operation by a user.

The entire storage area of the HDD 117 includes not only a data area, but a system area, a program storage area, etc. When data in the entire storage of the HDD 117 is encrypted, a high level of security can be ensured. Also, the encryption control program 203 can be provided between the software (the OS 201, the various application programs, etc.) and the HDD 117. To be more specific, when receiving a write request from the software, the encryption control program 203 encrypts data included in the write request, and writes the encrypted data to the HDD 117. Also, when receiving a read request from the software, the encryption control program 203 reads the encrypted data from the HDD 117, decrypts the read data, and sends the decrypted data to the software. Thereby, during execution of the software, data in the HDD 117 can be encrypted.

Furthermore, the CPU 111 executes a basic input output system (BIOS) stored in a BIOS-ROM 116 which is a nonvolatile memory. The BIOS is a system program for controlling hardware.

A GPU 114 is a display controller configured to control an LCD 31 used as a display monitor of the computer 10. The GPU 114 produces a display signal (LVDS signal) to be supplied to the LCD 31, from display data stored in a video memory (VRAM) 114A. Furthermore, the GPU 114 can produce an analog RGB signal and an HDMI video signal from the display data. The analog RGB signal is supplied to an external display through an RGB port 24. The HDMI output terminal 23 enables an HDMI video signal (uncompressed digital video signal) and a digital audio signal to be sent to the external display with a single cable. An HDMI control circuit 119 is an interface configured to send the HDMI video signal and the digital audio signal to the external display through the HDMI output terminal 23.

The system controller 112 is a bridge device configured to connect the CPU 111 and components. The system controller 112 incorporates a serial ATA controller configured to control the HDD 117. Also, the system controller 112 communicates with each of devices on a low PIN count (LPC) bus.

The EC/KBC 130 is connected to the LPC bus. The EC/KBC 130, a power supply controller (PSC) 141 and the battery 20 are connected to each other by a serial bus such as an I²C bus.

The EC/KBC 130 is a power management controller configured to manage power of the computer 10, and can be provided as, e.g., a one-chip microcomputer incorporating a keyboard controller configured to control the keyboard (KB) 13, the touch pad 14, etc. The EC/KBC 130 has a function of turning on/off the computer 10 in accordance with an operation of a power supply switch 16 by the user.

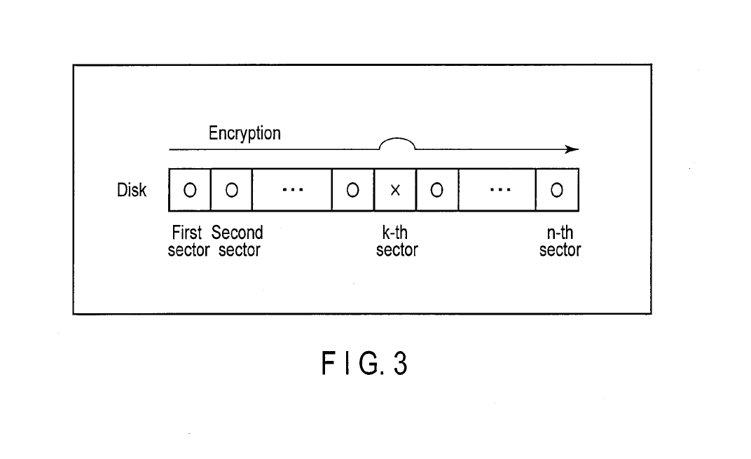

Next, an outline of the embodiment will be explained with reference to FIG. 3.

As shown in FIG. 3, in the case where the entire storage area of the HDD 117 includes n sectors, i.e., first to n-th sectors, and the data in the HDD 117 is encrypted, the data in the sectors of the HDD 117 is successively encrypted from that in the first sector to that in the n-th sector (in the following ascending order: the first sector, second sector, . . . , k-th sector, . . . , and n-th sector). It should be noted that the first sector is, e.g., the lead one of a plurality of sectors in the entire storage area. The sector number of the lead sector is, e.g., the lowest one of the sector numbers of the plurality of sectors in the entire storage area. The n-th sector is, e.g., the last one of the plurality of sectors in the entire storage area. The sector number of the last sector is, e.g., the highest one of the sector numbers of the plurality of sectors in the entire storage area.

Furthermore, during encryption of the data in the HDD 117, there is a case where a defective sector whose data cannot be read is detected. In this case, in the embodiment, the encryption control program 203 stores address information on a detected defective sector in a predetermined storage area (defective sector list). Also, the encryption control program 203 continuously executes encryption of the data in the HDD 117. Then, after completion of the encryption of the data in the HDD 117, if the software makes an access request for accessing to a defective sector (a sector whose data is not encrypted) stored in the defective sector list, the encryption control program 203 performs recovery (encryption) on the defective sector requested to be accessed. Thus, even if a sector is detected as a defective one, it is skipped in encryption, and thus the encryption of the data in the HDD 117 can be completed. Furthermore, based on the defective sector list, recovery and encryption can be performed on sectors whose data is not encrypted. Therefore, the data in the HDD 117 can be reliably encrypted. It should be noted that in the embodiment, the defective sector list is used for encryption of data in a sector or sectors which is not yet encrypted, not for recovery of a detected defective sector or sectors. In this sense, it can be said that the defective sector list is a list of sectors skipped in encryption.

The defective sector, as described above, is a sector whose data cannot be read. For example, if data is stored along with an error-correcting code (ECC) in a sector, and an error of the data in the sector cannot be corrected even with the ECC, the sector is detected as a defective sector.

The address information on a defective sector is information indicating where the defective sector is located on the HDD 117. The address information on the defective sector is information including, e.g., a logic block address (LBA).

The access request for accessing the defective sector is a request for writing data to the defective sector, or a request for reading data from the defective sector or the like.

The recovery to be performed on the defective sector means processing for making the sector recover from a defective state to a normal state in which data can be read from and written to the sector.

More specifically, as shown in FIG. 3, if the k-th sector is detected as a defective sector, address information on the k-th sector is stored in the defective sector list. Thus, the k-th sector is skipped, and encryption is executed from a k+1-th sector which is subsequent to the k-th sector to the n-th sector. While data in the k+l-th to n-th sectors is being encrypted, if a defective sector is detected, address information on the defective sector is stored in the defective sector list. Then, after encryption of the n-th sector, recovery is performed on the defective sector, e.g., the k-th sector. The recovery on the k-th sector is performed, for example, when a write/read request for writing data to or reading data from the k-th sector, which is made from the software, is received. To be more specific, when the above write request made by the software is received, the encryption control program 203 encrypts data included in the write request, and writes the encrypted data to the k-th sector. If the encrypted data is successfully written to the k-th sector, i.e., encryption of data in the k-th sector is completed, the encryption control program 203 deletes the address information on the k-th sector from the defective sector list. When the above read request made by the software is received, the encryption control program 203 reads data from the k-th sector. If the data is successfully read from the k-th sector, the encryption control program 203 encrypts the data, and writes the encrypted data to the k-th sector. If the encrypted data is successfully written to the k-th sector; i.e., encryption of data in the k-th sector is completed, the address information on the k-th sector is deleted from the defective sector list. In such a manner, processing for performing recovery on a defective sector in response to the write/read request from the software, i.e., processing for performing encryption on a sector whose data is not yet encrypted, is automatically executed. Thus, those recovery and encryption processing on the defective sector can be efficiently executed.

It should be noted that if a defective sector is detected, it may be made to recover before data in remaining sectors is encrypted to data in the n-th sector.

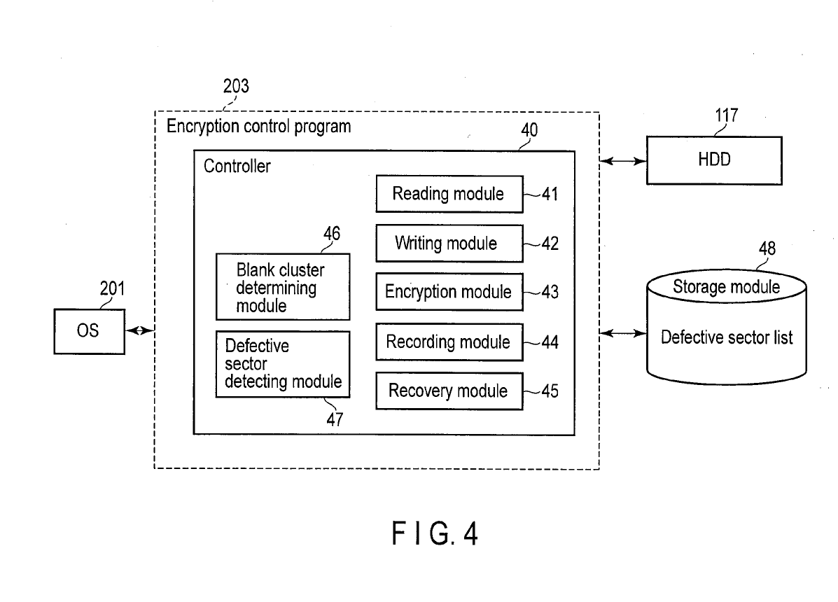

Next, a configuration of the encryption control program 203 will be explained with reference to FIG. 4.

The encryption control program 203 includes a controller 40. The controller 40 includes a reading module 41, a writing module 42, an encryption module (processor) 43, a recording module 44, a recovery module 45, a blank cluster determining module 46 and a defective sector detecting module 47. Also, the encryption control program 203 operates in cooperation with an OS 201 and a device driver 202.

The device driver 202 is a drive program for use in accessing the HDD 117 to read and write data from and to the HDD 117. The encryption control program 203 can read and write data from and to the HDD 117 with the device driver 202. The defective sector detecting module 47 detects a defective sector.

The blank cluster determining module 46 determines whether the defective sector detected by the defective sector detecting module 47 is present in a blank cluster or not. The blank cluster is a cluster not used by a file system of the OS 201. The cluster not used by the file system is, e.g., a cluster to which effective data is written. Also, it can be determined whether the detected defective sector is a blank cluster or not, with a function of the OS 201 which is provided to check a cluster being used. Also, it can be determined by analyzing an NTFS or a FAT which manages a location where data of a file is written.

Duration encryption of data in the HDD 117, the controller 40 detects a defective sector whose data cannot be read, and stores address information on the detected defective sector in the defective sector list in a storage module 48.

The reading module 41 reads data from the HDD 117 in response to a read request from software such as the OS 201. The writing module 42 writes data to the HDD 117 in response to a write request from the software such as the OS 201. The encryption module 43 encrypts the data read by the reading module 41. The encrypted data is written to the HDD 117 by the writing module 42.

The recording module 44 stores address information on the defective sector in the defective sector list in the storage module 48. The recording module 44 is, e.g., a nonvolatile memory such as a hard disk, in the HDD 117.

The recovery module 45 makes the defective sector recover based on the defective sector list. Also, if the defective sector detecting module 47 detects a defective sector, the recovery module 45 can also immediately make the detected defective sector recover. In this case, the recovery module 45 determines whether the defective sector detected by the defective sector detecting module 47 is part of a blank cluster not holding effective data or not. If the defective sector is part of the blank cluster, the recovery module 45 writes dummy data to the defector sector in order to make the defective sector recover. Then, the recovery module 45 reads the dummy data from the defective sector. If the dummy data is successfully read from the defective sector, address information on the defective sector is not stored in the defective sector list.

The defective sector list is a list of defective sectors detected by the defective sector detecting module 47. It should be noted that as described above, in the case where the detected defective sectors are immediately made to recover by the recovery module 45, of address information on those defective sectors, only address information on a defective sector or sectors not made to recover (unrecoverable sectors) is stored in the defective sector list.

It should be noted that the recovery module 45 may make the defective sector recover while encryption is being performed or after encryption is completed.

Also, after the defective sector is detected, if the above write or read request for writing or reading data to or from the defective sector is made before encryption is completed, the recovery module 45 may make defective sector recover to respond to the request.

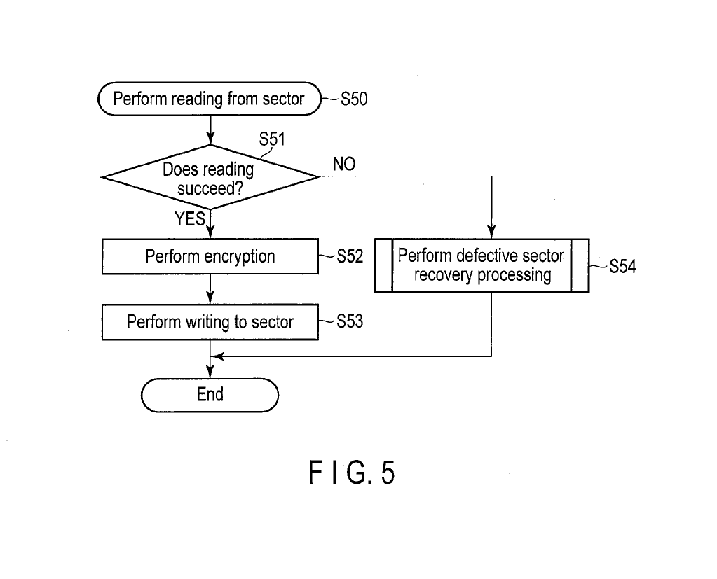

Next, a procedure of encryption control processing in the embodiment will be explained with reference to FIG. 5.

The encryption control program 203 executes the following processing on each of all the sectors in the entire storage area in the HDD 117.

First, the encryption control program 203 reads data from a target sector (step S50). Then, the encryption control program 203 determines whether the data is successfully read from the target sector or not; i.e., whether the sector is a defective sector or not (step S51). If the encryption control program 203 successfully reads the data (Yes in Step S51), it encrypts the read data (step S52). Next, the encryption control program 203 writes the encrypted data to the above sector (step S53). In step S51, if the encryption control program 203 does not successfully read the data, i.e., it fails to read the data (No in step S51), the step to be carried out proceeds to step S54. In step S54, the encryption control program 203 makes the defective sector recover.

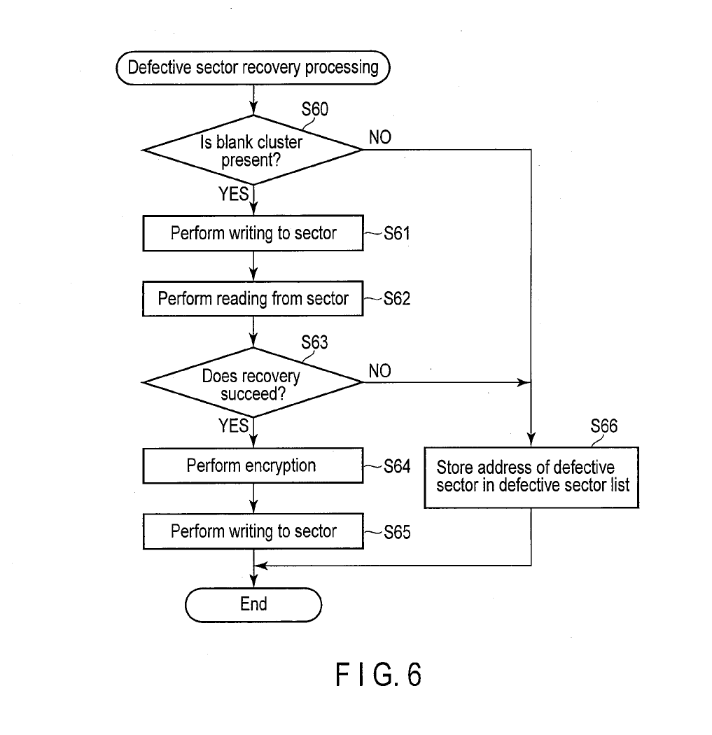

Next, a procedure of a recovery processing of the defective sector in the encryption control processing in the embodiment will be explained with reference to FIG. 6. FIG. 6 is a view for explaining the processing of step S54 in FIG. 5 in more detail.

The encryption control program 203 determines whether a cluster corresponding to the defective sector is a blank cluster or not (step S60). If determining that the cluster corresponding to the defective sector is a blank cluster (Yes in step S60), the encryption control program 203 writes dummy data to the defective sector (step S61). Then, the encryption control program 203 reads the dummy data from the defective sector (step S62). The encryption control program 203 determines whether the recovery performed on the defective sector succeeds or fails, in accordance with whether the dummy data is successfully read from the defective sector or not (step S63). If the encryption control program 203 successfully reads the dummy data from the defective sector, it determines that the recovery on the defective sector succeeds. If the recovery on the defective sector succeeds (Yes in step S63), the encryption control program 203 encrypts the read dummy data (step S64). The encryption control program 203 writes the encrypted dummy data to the defective sector (step 65).

Furthermore, if the cluster corresponding to the defective sector is not a blank cluster (No in step S60) or the recovery on the defective sector fails (No in step S63), the encryption control program 203 stores address information on the defective sector in the defective sector list (step S66).

It should be noted that if the defective sector is detected, the encryption control program 203 may store the address information on the defective sector in the defective sector list, without performing such recovery on the defective sector as disclosed in FIG. 6.

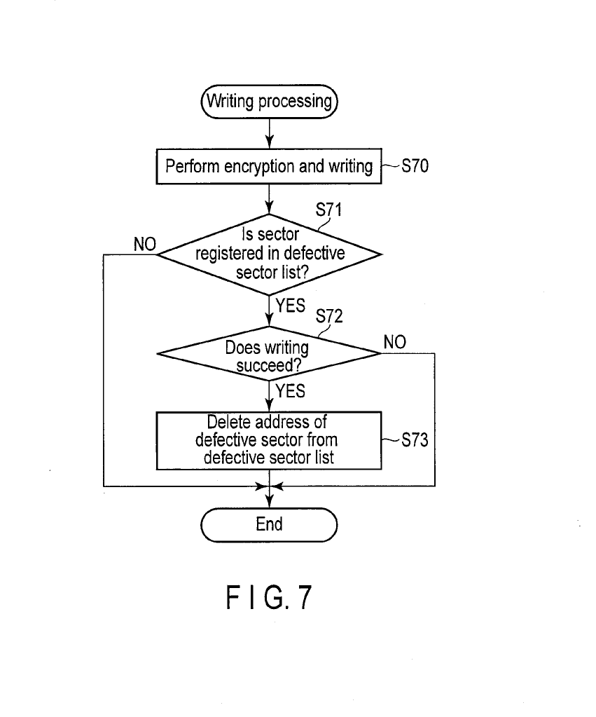

Next, a procedure of processing to be executed by the encryption control program 203 when a write request for writing data to a sector registered in the defective sector list is received will be explained with reference to the flowchart of FIG. 7.

When a write request for writing data to the HDD 117 is made by the OS 201 or the like, the encryption control program 203 starts to execute such processing as disclosed in FIG. 7. To be more specific, the encryption control program 203 encrypts data included in the write request, and writes the encrypted data to a sector associated with a logic block address included in the write request (step S70). Next, referring to the defective sector list, the encryption control program 203 determines whether the sector to which the data is to be written is a defective sector registered in the defective sector list or not (step S71). If the sector to which the data is to be written is a defective sector registered in the defective sector list (Yes in step S71), the encryption control program 203 determines whether the data is successfully written to the sector determined as the defective sector or not (step S72). In the step S72, the encryption control program 203 may determine whether the data is successfully written to the defective sector, in accordance with whether it successfully reads the data from the defective sector or not.

If successfully writing the data to the defective sector (Yes in step S72), the encryption control program 203 deletes address information on the defective sector from the defective sector list (step S73). In other words, if successfully writing the data to the defective sector (Yes in step S72), the encryption control program 203 excludes the defective sector from sectors to be made to recover (step S73). In such a manner, if the encrypted data is successfully written to a defective sector registered in the defective sector list, it means that data in the defective sector is encrypted. In fact, the address information on the defective sector is deleted from the defective sector list.

If the sector to which the data is to be written is not any of defective sectors registered in the defective sector list (No in step S71) or writing of data to the defective sector fails (No in step S72), the encryption control program 203 ends the encryption control processing disclosed in FIG. 7.

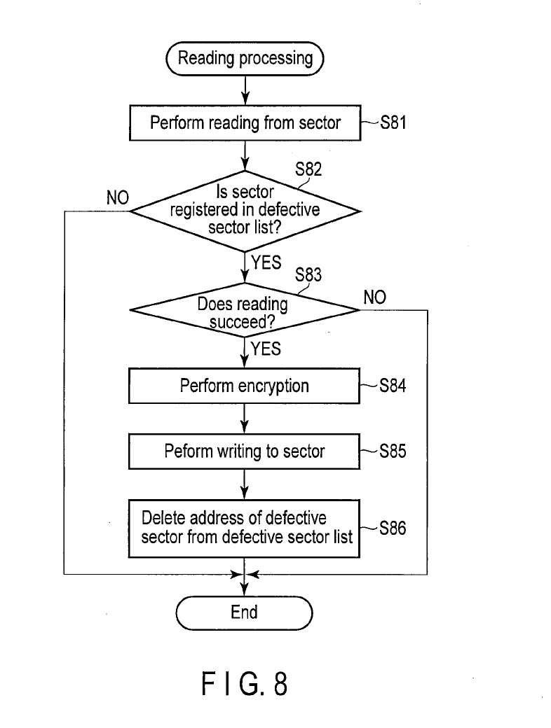

Next, a procedure of processing to be executed by the encryption control program 203 when a read request for reading data from a sector registered in the defective sector list is received will be explained with reference to the flowchart of FIG. 8.

When a read request for reading data from the HDD 117 is made by the OS 201 or the like, the encryption control program 203 starts to execute such processing as disclosed in FIG. 8. To be more specific, in response to the read request, the encryption control program 203 reads data from a sector associated with a logic block address specified by the read request (step S81). The encryption control program 203 determines whether the above sector is a defective sector registered in the defective sector list (step S82).

If determining that the sector is a defective sector registered in the defective sector list (Yes in step S82), the encryption control program 203 determines whether it successfully reads data from the sector determined as the defective sector (step S83). It should be noted that in general, there is a case where when data in the defective sector is re-read, magnetism is enhanced, as a result of which the data in the defective sector can be read.

If successfully reading data from the defective sector (Yes in step S83), the encryption control program 203 encrypts the read data (step S84). Then, the encryption control program 203 writes the encrypted data to the defective sector (sector to be made to recover) (step S85). The encryption control program 203 deletes address information on the defective sector to which the encrypted data is written, from the defective sector list (step S86). In other words, the encryption control program 203 excludes the above defective sector from sectors to be made to recover (step S86).

Furthermore, if the data read in step S81 is encrypted data, the encryption control program 203 decrypts the read data, i.e., it executes processing for restoring the encrypted data to its former state, and sends the decrypted data to the OS 201 or the like.

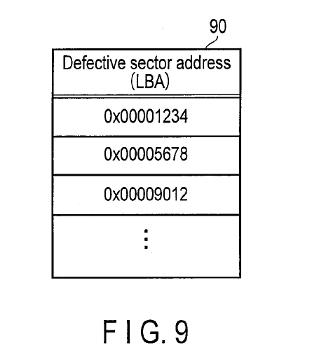

An example of the defective sector list will be explained with reference to FIG. 9.

As shown in FIG. 9, a defective sector list 90 stores logic block addresses (LBAs) respectively associated with defective sectors as defective sector addresses.

Each of the defective sector addresses is information indicating the position of an associated one of the defective sectors on the hard disk. The defective sector address is indicated in such a way as shown in FIG. 9, e.g., “0x00001234”.

As explained above, in the embodiment, while data in a storage device such as a hard disk is being encrypted in units of one sector, if a defective sector whose data cannot be read is detected, address information on the detected defective sector is stored. Thus, referring to the address information, the data of the defective sector can be later encrypted. Also, even if a defective sector is detected during encryption, it is subjected to the recovery and encryption processing, as a result of which its data can be completely encrypted. Further, if a write request for writing data to a defective sector registered in the defective sector list is made, data included in the write request is encrypted and written to the defective sector. Thus, if this writing succeeds, the address information on the defective sector is deleted from the defective sector list, thus decreasing the number of defective sectors whose data need to be encrypted. Furthermore, if a read request for reading data from a defective sector registered in the defective sector list is made, and then if the data in the defective sector is successfully read, the data in the defective sector is encrypted, and the address information on the defective sector is deleted from the defective sector list. Thus, the number of defective sectors whose data need to be encrypted is decreased. In addition, if a defective sector (first sector) is detected during encryption, and a cluster corresponding to the defective sector is a blank cluster, dummy data is written to the defective sector, and read from the defective sector, as a result of which the defective sector is made to recover. If the dummy data written to the defective sector is successfully read therefrom, encryption is re-performed on the defective sector to complete encryption of the defective sector.

It should be noted that as to the embodiment, although the above explanation is given with respect to the case where the data in the HDD 117 is encrypted, such encryption control processing as described above can also be executed on a nonvolatile memory such as a solid-state drive (SSD), in which data can be encrypted in predetermined units.

Also, the function of the encryption control program 203 explained with respect to the embodiment may be achieved with hardware such as a dedicated LSI, DSP or a microcomputer.

The steps of the encryption control processing in the embodiment can be all carried out by software. Thus, the same advantage as in the embodiment can be obtained simply by installing a computer program which carries out the steps of the encryption control processing onto an ordinary computer via a computer-readable storage medium storing the above computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
storage comprising a plurality of sectors; and
a processor configured to encrypt data in the plurality of sectors of the storage,
wherein the processor is configured to cause to be stored in a storage area address information indicating a defective sector from which data cannot be read, when the defective sector is detected during encryption.

2. The electronic device of claim 1, wherein
the processor is configured to encrypt data included in a write request, and to write encrypted data to a first sector, when the processor receives the write request from software executed on the electronic device, wherein the write request comprises a request for writing data to the first sector indicated by address information stored in the storage area, and
the processor is configured to cause the address information indicating the first sector to be deleted from the storage area, when writing the encrypted data to the first sector succeeds.

3. The electronic device of claim 1, wherein
the processor is configured to read data from a first sector, when the processor receives a read request from software executed on the electronic device, wherein the read request comprises a request for reading data from the first sector indicated by address information stored in the storage area,
the processor is configured to encrypt read data, and to write encrypted data to the first sector, when reading the data from the first sector succeeds, and
the processor is configured to cause the address information indicating the first sector to be deleted from the storage area, when writing the encrypted data to the first sector succeeds.

4. The electronic device of claim 1, wherein
the processor is configured to determine whether the defective sector is a blank cluster, when the defective sector is detected during the encryption of data in the plurality of sectors,
the processor is configured to write dummy data to the defective sector when the defective sector is determined to be the blank cluster;
the processor is configured to read the dummy data from the defective sector;
the processor is configured to
encrypt the dummy data, when reading the dummy data from the defective sector succeeds,
write encrypted dummy data to the defective sector, and
continue the encryption of the data in the plurality of sectors without causing the address information to be stored in the storage area.

5. The electronic device of claim 4, wherein
the processor is configured to cause the address information to be stored in the storage area, when reading the dummy data from the defective sector fails.

6. The electronic device of claim 1, wherein the address information comprises a logic block address allocated to the defective sector.

7. The electronic device of claim 1, wherein the storage comprises a hard disk drive or a solid-state drive.

8. A method of encrypting data, comprising:
encrypting data in a plurality of sectors of storage in an electronic device;
storing in a storage area address information indicating a defective sector from which data cannot be read, when during encryption the defective sector is detected.

9. The encryption method of claim 8, further comprising
encrypting, when a write request for writing data to a first sector indicated by address information stored in the storage area is received, data included in the write request, the write request being made by software executed on the electronic device;
writing encrypted data to the first sector; and
deleting, when writing the encrypted data to the first sector succeeds, the address information indicating the first sector from the storage area.

10. The encryption method of claim 8, further comprising
reading data from a first sector, when a read request for reading data from the first sector indicated by address information stored in the storage area is received, the read request being made by software executed on the electronic device;
encrypting read data, when reading the data from the first sector succeeds;
writing encrypted data to the first sector; and
deleting from the storage area the address information indicating the first sector, when writing the encrypted data to the first sector succeeds.

11. A non-transitory computer-readable storage medium storing computer-executable instructions that, when executed, cause a computer to:
encrypt data in a plurality of sectors of storage in the computer; and
store in an storage area address information indicating a defective sector from which data cannot be read, when during encryption the defective sector is detected.

12. The storage medium of claim 11, further causes the computer to
encrypt, when a write request for writing data to a first sector indicated by address information stored in the storage area is received, data included in the write request, the write request being made by software executed on the computer;
write encrypted data to the first sector; and
delete, when writing the encrypted data to the first sector succeeds, the address information indicating the first sector from the storage area.

13. The storage medium of claim 11, further causes the computer to
read from a first sector, when a read request for reading data from a first sector indicated by address information stored in the storage area is received, the read request being made by software executed on the computer;
encrypt read data, when reading the data from the first sector succeeds;
write encrypted data to the first sector; and
delete from the storage area the address information indicating the first sector, when writing the encrypted data to the first sector succeeds.
